(19) United States
(12) Patent Application Publication
(10) Pub. No.: US 2016/0133165 A1
(43) Pub. Date: May 12, 2016

(54) ELECTRONIC LABELLING DEVICE

(71) Applicant: STORE ELECTRONIC SYSTEMS, Argenteuil (FR)

(72) Inventor: Bernard Joliey, Saint-Raphaël (FR)

(21) Appl. No.: 14/784,504

(22) PCT Filed: Apr. 2, 2014
(86) PCT No.: PCT/FR2014/050787

§ 371 Date: Oct. 14, 2015

(30) Foreign Application Priority Data
Apr. 17, 2013 (FR) 1353468

(51) Int. Cl. G09F 3/20

(52) U.S. Cl. CPC G09F 3/208; G09F 3/204

(57) ABSTRACT

The invention relates to an electronic labelling device formed by a label holder and at least one electronic label. The electronic label is formed by a display screen (8), an electronic unit (9) and a connecting plate (10). The back of the screen (8) comprises a rib (12) for hooking to a groove in the label holder such that only the screen (8) is visible.

The invention relates to an electronic labeling device particularly suited to the field of perfumery, cosmetics, pharmacy or para-pharmacy.

In this field, the space available for products is limited, and the product locations frequently change. It is therefore necessary to provide a labeling device that is small in size, to simplify the operations of attaching and detaching the electronic labels, and to fix the electronic labels onto the fronts of the shelves quickly.

It is an object of the invention to propose an electronic labeling device that meets these requirements.

It is another object of the invention to propose an electronic labeling device, the visible label of which is thin.

The subject of the invention is an electronic labeling device consisting of a label support and of at least one electronic label; the label support comprising a rear part able to be fixed to the edge of a shelf, and a front part able to accept an electronic label; the electronic label comprising a display screen; characterized in that: the front part of the label support is a frontal plate having an elastically deformable omega-shaped groove, in that the electronic label is made up of a display screen, of an electronic unit and of a connecting plate, and in that the screen on its rear face bears an omega-shaped rib able to be inserted in the groove to fix the electronic label to the label support.

Advantageously, the connecting plate constitutes, to the rear of the screen, a base that is common to the screen and to the electronic unit and which is positioned at the lower part thereof.

Advantageously, the connecting plate is long enough for the space between the rib and the electronic unit to be wide enough to allow the front part of the label support and its groove to pass through.

Advantageously, with the electronic label in place on the label support, the electronic unit is housed behind the front part of the label support, and only the screen of the electronic label is visible.

Other features and advantages of the invention will become apparent from the following description of one exemplary embodiment given by way of non-limiting illustration with reference to the attached drawings in which:

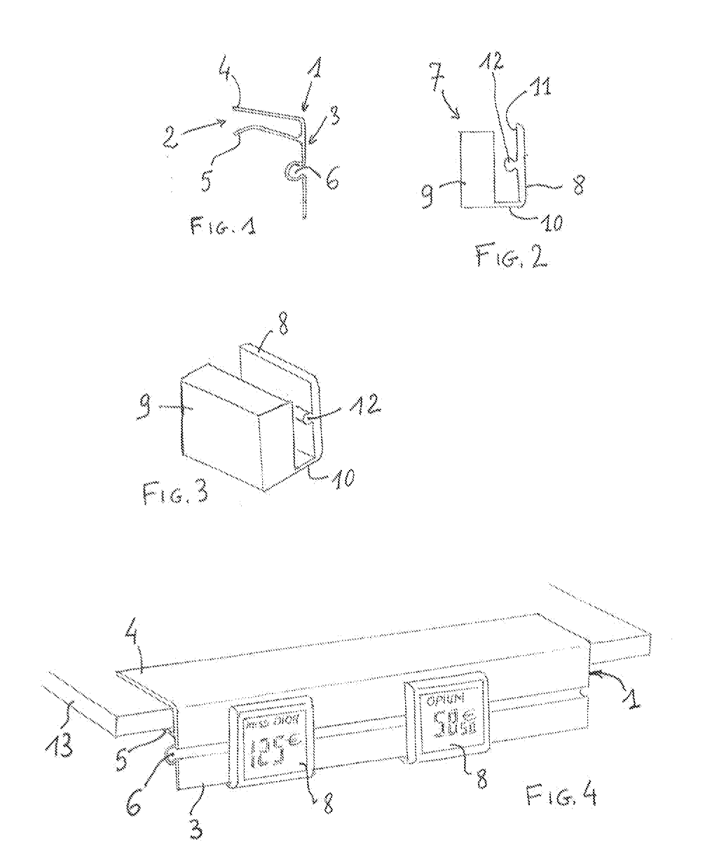

FIG. 1 is a view in cross section of a label support according to the invention;

FIG. 2 is a view in cross section of an electronic label according to the invention;

FIG. 3 is a perspective view of the electronic label of FIG. 2;

FIG. 4 is a perspective view of an electronic labeling device according to the invention, in place on a shelf.

The electronic labeling device according to the invention is made up of a label support and of at least one electronic label. The label support 1 takes the form of a rail comprising a rear part 2 and a front part 3. The rear part 2 is made up of an upper plate 4 intended to be pressed against a shelf, and of a bent lower plate 5 intended to press against the underside of the shelf, the two plates 4 and 5 acting as a clip gripping the edge of the shelf. The front part 3 is a frontal plate, which, in the middle zone thereof has an elastically deformable omega-shaped longitudinal groove 6, the opening of the groove being visible on the frontal plate. The front part 3 of the label support is able to accept at least one electronic label 7.

The electronic label 7 is made up of three parts: a display screen 8, an electronic unit 9 and a connecting plate 10. The display screen 8 constitutes the part of the electronic label 7 that is visible when the label is in place on the label support. The display screen 8 is thin and contains only those elements necessary for the display visible on the frontal face thereof. On its rear face 11, the screen 8 has an omega-shaped horizontal rib 12. The dimensions of the rib 12 correspond to those of the groove 6 so that the rib 12 can be inserted into the groove 6 to attach the electronic label 7 to the label support 1.

The electronic unit 9, positioned to the rear of the screen 8, contains the elements necessary for the operation of the electronic label, such as the battery, telecommunications electronic circuits, microprocessor and display screen control circuits. The electronic unit 9 takes the form of a rectangular parallelepiped, the widthwise and heightwise dimension of which are substantially the same as those of the screen 8, but the thickness of which is substantially greater.

The connecting plate 10 constitutes, to the rear of the screen 8, a base that is common to the screen 8 and to the electronic unit 9 and is positioned at the lower part thereof, and is horizontal when the screen 8 is vertical. The connecting plate 10 contains the electronic connections between the electronic unit 9 and the screen 8. It is rigid enough that the electronic label 7 assembly is not substantially deformable. It is long enough for the space between the rib 12 and the electronic unit 9 to be wide enough to allow the front part 3 of the label support 1 and the groove 6 thereof to pass through.

The electronic labeling device is fitted as follows. The label support 1 is fixed via its rear part to the edge of a shelf 13, with the upper plate 4 above and the lower plate 5 below the shelf. The electronic label 7 is placed under the front part 3 of the label support 1 and raised up so that the front part 3 and the groove 6 of the label support 1 become inserted between the electronic unit 9 and the rib 12 of the screen 8. The rib 12 is positioned against the opening of the groove 6. Manual pressure on the screen 8 causes the opening of the groove 6 to widen elastically allowing the rib 12 to be clipped into the groove 6.

Thus, when the electronic label 7 is in place on the label support 1, the electronic unit 9 is housed behind the front part 3 of the label support 1 and only the screen 8 of the electronic label 7 is visible.

The electronic label is extracted by manually pressing on the bottom of the screen 8 and manually pulling the top of the screen 8.

1. An electronic labeling device comprising:
a label support; and
at least one electronic label;
wherein the label support has a rear part able to be fixed to the edge of a shelf, and a front part able to accept an electronic label; and
wherein the electronic label has a display screen where the front part of the label support is a frontal plate having an elastically deformable omega-shaped groove, in that the electronic label is made up of a display screen, of an electronic unit and of a connecting plate, and in that the screen on its rear face bears an omega-shaped rib able to be inserted in the groove to fix the electronic label to the label support.

2. The electronic labeling device as claimed in claim 1, wherein the connecting plate constitutes, to the rear of the screen, a base that is common to the screen and to the electronic unit and which is positioned at the lower part thereof.

3. The electronic labeling device as claimed in claim 2, wherein the connecting plate is long enough for the space between the rib and the electronic unit to be wide enough to allow the front part of the label support and its groove to pass through.

4. The electronic labeling device as claimed in claim 3, wherein with the electronic label is place on the label support, the electronic unit is housed behind the front part of the label support, and only the screen of the electronic label is visible.
